(19) United States
(12) Patent Application Publication
(10) Pub. No.: US 2024/0422738 A1
(43) Pub. Date: Dec. 19, 2024

(54) PAGING INDICATION METHOD AND APPARATUS, TERMINAL, AND NETWORK SIDE DEVICE

(71) Applicant: VIVO MOBILE COMMUNICATION CO., LTD., Dongguan (CN)

(72) Inventors: Xuanbing LIU, Dongguan (CN); Li CHEN, Dongguan (CN)

(73) Assignee: VIVO MOBILE COMMUNICATION CO., LTD., Dongguan (CN)

(21) Appl. No.: 18/820,237

(22) Filed: Aug. 29, 2024

Related U.S. Application Data
(63) Continuation of application No. PCT/CN2023/078123, filed on Feb. 24, 2023.

(30) Foreign Application Priority Data
Mar. 1, 2022 (CN) 202210194817.1

(51) Int. Cl. H04W 68/02; H04W 76/27

(52) U.S. Cl. CPC H04W 68/02; H04W 76/27

(57) ABSTRACT

This application discloses a paging indication method and apparatus, a terminal, and a network side device. The paging indication method includes: when a target condition is met, a terminal uses at least one of a paging early indication (PEI) or a paging subgroup in a current cell, where the target condition includes at least one of the following: the terminal is in a non-connected state in the current cell; the current cell does not restrict the terminal from using at least one of the PEI or the paging subgroup; or the terminal is assigned a core network subgroup identity in the current cell.

### CROSS-REFERENCE TO RELATED APPLICATIONS

This application is a continuation of International Application No. PCT/CN2023/078123, filed Feb. 24, 2023, which claims priority to Chinese Patent Application No. 202210194817.1, filed Mar. 1, 2022. The entire contents of each of the above-referenced applications are expressly incorporated herein by reference.

### TECHNICAL FIELD

This application relates to the field of communication technologies, and specifically relates to a paging indication method and apparatus, a terminal, and a network side device.

### BACKGROUND

In a communication system, within one Discontinuous Reception (DRX) cycle, a terminal may monitor, only at a Paging Occasion (PO) on a corresponding paging frame, whether a Paging Radio Network Temporary Identifier (P-RNTI) is carried on a Physical downlink control channel (PDCCH), and then determine whether a paging message is carried on a corresponding Physical downlink shared channel (PDSCH).

For a New Radio (NR), to support a flexible network configuration, a network side may send a configuration of a Paging Early Indication (PEI) based on a system message to indicate to use the PEI. However, the terminal and the network side may have an inconsistent understanding of the PEI or a paging subgroup. For example, the terminal monitors the PEI in a current cell, but the network does not send the PEI. As a result, paging is lost, and terminal communication is affected.

### SUMMARY

Embodiments of this application provide a paging indication method and apparatus, a terminal, and a network side device.

According to a first aspect, a paging indication method is provided, including:
in a case that a target condition is met, a terminal uses at least one of a paging early indication PEI or a paging subgroup in a current cell, where
the target condition includes at least one of the following:
the terminal is in a non-connected state in the current cell;
the current cell does not restrict the terminal from using at least one of the PEI or the paging subgroup; or
the terminal is assigned a core network subgroup identity document in the current cell.

According to a second aspect, a paging indication method is provided, including:
a network side device sends a system message or a first radio resource control RRC message to a terminal, where the system message or the first RRC message includes at least one of the following:
a message used to indicate whether the terminal is allowed to use at least one of a paging early indication PEI or a paging subgroup in a current cell;
a message used to indicate whether a current cell on which the terminal camps is a last used cell; or
a first indication, where the first indication is used to indicate whether at least one of a PEI or a paging subgroup is used only in a last used cell of the terminal.

According to a third aspect, a paging indication apparatus is provided, including:
an execution module, configured to: in a case that a target condition is met, use at least one of a paging early indication PEI or a paging subgroup in a current cell, where
the target condition includes at least one of the following:
the apparatus is in a non-connected state in the current cell;
the current cell does not restrict the apparatus from using at least one of the PEI or the paging subgroup; or
the apparatus is assigned a core network subgroup identity document in the current cell.

According to a fourth aspect, a paging indication apparatus is provided, including:
a sending module, configured to send a system message or a first radio resource control RRC message to a terminal, where the system message or the first RRC message includes at least one of the following:
a message used to indicate whether the terminal is allowed to use at least one of a paging early indication PEI or a paging subgroup in a current cell;
a message used to indicate whether a current cell on which the terminal camps is a last used cell; or
a first indication, where the first indication is used to indicate whether at least one of a PEI or a paging subgroup is used only in a last used cell of the terminal.

According to a fifth aspect, a terminal is provided. The terminal includes a processor and a memory, and the memory stores a program or an instruction that can be run on the processor. When the program or the instruction is executed by the processor, the steps of the method according to the first aspect are implemented.

According to a sixth aspect, a terminal is provided, including a processor and a communication interface. The processor is configured to: in a case that a target condition is met, use at least one of a paging early indication PEI or a paging subgroup in a current cell, where
the target condition includes at least one of the following:
the terminal is in a non-connected state in the current cell;
the current cell does not restrict the terminal from using at least one of the PEI or the paging subgroup; or
the terminal is assigned a core network subgroup identity document in the current cell.

According to a seventh aspect, a network side device is provided. The network side device includes a processor and a memory, and the memory stores a program or an instruction that can be run on the processor. When the program or the instruction is executed by the processor, the steps of the method according to the second aspect are implemented.

According to an eighth aspect, a network side device is provided, including a processor and a communication interface. The communication interface is configured to send a system message or a first radio resource control RRC message to a terminal, where the system message or the first RRC message includes at least one of the following:
a message used to indicate whether the terminal is allowed to use at least one of a paging early indication PEI or a paging subgroup in a current cell;
a message used to indicate whether a current cell on which the terminal camps is a last used cell; or
a first indication, where the first indication is used to indicate whether at least one of a PEI or a paging subgroup is used only in a last used cell of the terminal.

According to a ninth aspect, a communication system is provided, including a terminal and a network side device. The terminal may be configured to perform the steps of the paging indication method according to the first aspect, and the network side device may be configured to perform the steps of the paging indication method according to the second aspect.

According to a tenth aspect, a readable storage medium is provided. The readable storage medium stores a program or an instruction, and when the program or the instruction is executed by a processor, the steps of the paging indication method according to the first aspect or the steps of the paging indication method according to the second aspect are implemented.

According to an eleventh aspect, a chip is provided. The chip includes a processor and a communication interface, the communication interface is coupled to the processor, and the processor is configured to run a program or an instruction to implement the paging indication method according to the first aspect or the paging indication method according to the second aspect.

According to a twelfth aspect, a computer program/program product is provided. The computer program/program product is stored in a storage medium, and the computer program/program product is executed by at least one processor to implement the paging indication method according to the first aspect or the paging indication method according to the second aspect.

In the embodiments of this application, in a case that the target condition is met, the terminal uses at least one of the PEI or the paging subgroup in the current cell. In this way, the terminal can determine a case that the PEI and/or the paging subgroup can be used, and the network side device can flexibly configure the terminal to use the PEI and/or the paging subgroup. This ensures that the network side device and the terminal have a consistent understanding of using the PEI and/or the paging subgroup, avoids a case that paging message is missed, ensures that paging message is successfully received, and ensures communication between the terminal and the network side device.

### BRIEF DESCRIPTION OF DRAWINGS

FIG. 1 is a block diagram of a wireless communication system to which the embodiments of this application may be applied;

FIG. 2 is a flowchart of a paging indication method according to an embodiment of this application;

FIG. 3 is a flowchart of another paging indication method according to an embodiment of this application;

FIG. 4 is a structural diagram of a paging indication apparatus according to an embodiment of this application;

FIG. 5 is a structural diagram of another paging indication apparatus according to an embodiment of this application;

FIG. 6 is a structural diagram of a communication device according to an embodiment of this application;

FIG. 7 is a structural diagram of a terminal according to an embodiment of this application;

FIG. 8 is a structural diagram of a network side device according to an embodiment of this application; and

FIG. 9 is a structural diagram of another network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. In addition, objects classified by “first” and “second” are usually of a same type, and the number of objects is not limited. For example, there may be one or more first objects. In addition, in the specification and claims, “and/or” represents at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR term is used in most of the following description, although these technologies can also be applied to applications other than an NR system application, such as a 6^{th} Generation (6G) communication system.

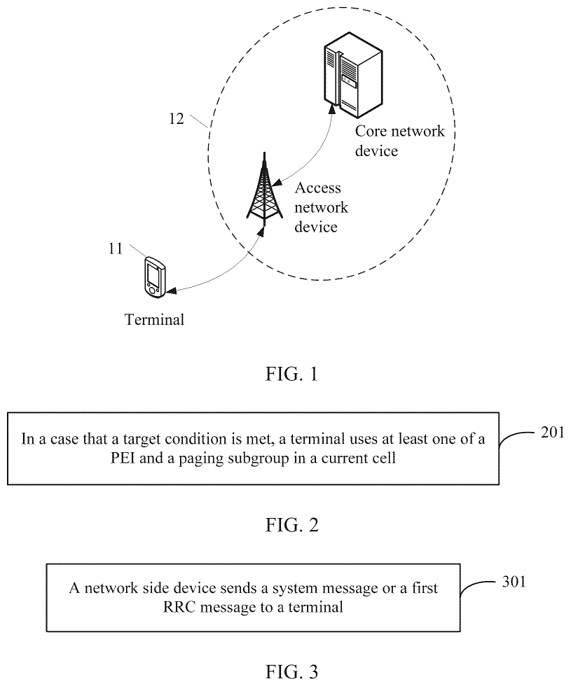

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, a smart chain anklet, or the like), a smart wrist strap, smart clothing, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a WLAN access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but be not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), or the like. It should be noted that, in the embodiments of this application, only a core network device in an NR system is used as an example for description, and a specific type of the core network device is not limited.

Currently, the network side device may send paging to the terminal in an idle state, an inactive state, or a connected state. A paging process may be triggered by the core network device, and is used to notify a terminal to receive a paging, or may be triggered by an eNB/gNB, and is used to notify the system of information update, and notify the terminal of receiving information from an Earthquake and Tsunami Warning System (ETWS), a Commercial Mobile Alert Service (CMAS), and the like.

Within one DRX cycle, the terminal may monitor, only at a Paging Occasion (PO) on a corresponding Paging Frame (PF), whether a Paging Radio Network Temporary Identifier (P-RNTI) is carried on a Physical downlink control channel (PDCCH), and then determine whether a paging message is carried on a corresponding physical downlink shared channel (PDSCH).

Further, the network side device may subgroup terminals that monitor a same PO, and indicate, based on the PEI, a terminal subgroup that is paged.

In LTE, a paging with wake up signal is one kind of paging reception signal based on a paging early indication, and the network side device may use the paging early indication only in a last used cell.

With reference to the accompanying drawings, a paging indication method provided in the embodiments of this application is described in detail by using some embodiments and application scenarios thereof.

FIG. 2 is a flowchart of a paging indication method according to an embodiment of this application. As shown in FIG. 2, the method includes the following step:

Step 201: In a case that a target condition is met, a terminal uses at least one of a PEI or a paging subgroup in a current cell.

The target condition includes at least one of the following:
the terminal is in a non-connected state in the current cell;
the current cell does not restrict the terminal from using at least one of the PEI or the paging subgroup; or
the terminal is assigned a core network subgroup identity document in the current cell.

In this embodiment of this application, in a case that the target condition is met, the terminal uses the PEI and/or the paging subgroup in the current cell. The current cell may be a cell on which the terminal currently camps.

For example, if the terminal moves from a cell 1 to a cell 2, the cell 2 is the current cell; and if the terminal is in a non-connected state in the cell 2, for example, the terminal is released in the cell 2, the terminal can use the PEI and/or the paging subgroup in the cell 2. In some embodiments, if the terminal is released in a cell 1, is reselected to a cell 2, and then returns to the cell 1, the cell 1 is the current cell. In some embodiments, if the terminal is assigned a core network subgroup identity document in a cell 1, the terminal can use the PEI and/or the paging subgroup in the cell 1. Movement of the terminal and the current cell may also have other possible cases, which are not enumerated in detail in this embodiment.

It should be noted that the target condition in this embodiment of this application may have a plurality of cases. In some embodiments, the target condition is that the current cell is a cell in which the terminal is recently released or suspended; or the target condition is that the terminal receives a first indication, and the first indication is used to indicate that at least one of the PEI or the paging subgroup is not required to be used only in a last used cell of the terminal, or a system message or Radio Resource Control (RRC) signaling received by the terminal in the current cell does not include a first indication; or the target condition is that the terminal is assigned a core network subgroup identity document in the current cell, and the current cell includes a corresponding paging subgroup configuration; or the target condition is that the terminal receives a first indication, where the first indication is used to indicate that at least one of the PEI or the paging subgroup is used only in a last used cell of the terminal, and the current cell is a cell in which the terminal is recently released or suspended; or the target condition is that the terminal receives a first indication, where the first indication is used to indicate that at least one of the PEI or the paging subgroup is used only in a last used cell of the terminal, and the current cell is a cell in which the terminal enters an idle state or an inactive state from a connected state; or the target condition is that the terminal is assigned a core network subgroup identity document in the current cell, and the terminal receives a first indication, where the first indication is used to indicate that at least one of the PEI or the paging subgroup is used only in a last used cell of the terminal. In some embodiments, the target condition may have other possible cases, and details are not described in this embodiment.

In this embodiment of this application, in a case that the target condition is met, the terminal uses at least one of the PEI or the paging subgroup in the current cell. In this way, the terminal can determine a case that the PEI and/or the paging subgroup can be used, and a network side device can flexibly configure the terminal to use the PEI and/or the paging subgroup. This ensures that the network side device and the terminal have a consistent understanding of using the PEI and/or the paging subgroup, ensures that paging is successfully received, and ensures communication between the terminal and the network side device.

In some embodiments, that the terminal is in a non-connected state in the current cell includes at least one of the following:
the terminal is released in the current cell, or the terminal is suspended in the current cell; or
the terminal enters the idle state or the inactive state from the connected state in the current cell.

For example, if the terminal is released in the current cell, the terminal can use at least one of the PEI or the paging subgroup in the current cell; or if the terminal is suspended (suspend) in the current cell, the terminal can use at least one of the PEI or the paging subgroup in the current cell; or if the terminal enters the idle state (IDLE) or the inactive state (RRC_INACTIVE) from the connected state in the current cell, the terminal can use at least one of the PEI or the paging subgroup in the current cell. In this way, based on the foregoing several cases, the terminal determines whether the PEI and/or the paging subgroup can be used in the current cell, to better standardize behavior of the terminal.

In some embodiments, that the terminal is released in the current cell, or the terminal is suspended in the current cell includes:
the terminal is most recently released in the current cell, or the terminal is most recently suspended in the current cell.

For example, if the current cell is a cell in which the terminal is most recently released, the terminal can use at least one of the PEI or the paging subgroup in the current cell; or if the current cell is a cell in which the terminal is most recently suspended, the terminal can use at least one of the PEI or the paging subgroup in the current cell.

It should be noted that the “most recently” may be understood as last time the terminal is released or suspended before the terminal moves to the current cell. For example, it is assumed that the target condition is that the terminal is most recently released in the current cell, or the terminal is most recently suspended in the current cell (or referred to as follows: the current cell is a cell in which the terminal is most recently released, or the current cell is a cell in which the terminal is most recently suspended). If the terminal is released or suspended in the cell 1, is reselected to the cell 2 and is released or suspended in the cell 2, and then returns to the cell 1 through cell selection or reselection, the current cell is the cell 1, and the terminal meets the following condition in the cell 1: The current cell is a cell in which the terminal is released or suspended, but is not a cell in which the terminal is most recently released or suspended, where the cell 2 is the cell in which the terminal is most recently released or suspended. In this case, the current cell does not meet the condition “the current cell is a cell in which the terminal is most recently released, or the current cell is a cell in which the terminal is most recently suspended”, and the terminal cannot use at least one of the PEI or the paging subgroup in the cell 1.

In some embodiments, that the terminal enters the idle state or the inactive state from the connected state in the current cell includes:
the terminal most recently enters the idle state or the inactive state from the connected state in the current cell.

In other words, if the current cell is a cell in which the terminal most recently enters the idle state or the inactive state from the connected state, the terminal can use at least one of the PEI or the paging subgroup in the current cell. For the definition of the “most recently”, refer to the description above. Details are not described herein again.

In this embodiment of this application, that the current cell does not restrict the terminal from using at least one of the PEI or the paging subgroup is implemented based on any one of the following:
the terminal receives a first indication, and the first indication is used to indicate that at least one of the PEI or the paging subgroup is not required to be used only in a last used cell of the terminal; or
a system message or radio resource control RRC signaling received by the terminal in the current cell does not include a first indication, and the first indication is used to indicate whether at least one of the PEI or the paging subgroup is used only in a last used cell of the terminal.

It should be noted that, in a case that the terminal receives the first indication, the first indication may be included in the system message or the RRC signaling sent by the network side device. If the first indication may be used to indicate whether at least one of the PEI or the paging subgroup is required to be used only in a last used cell, the first indication may be used to indicate that at least one of the PEI or the paging subgroup is used only in the last used cell, or the first indication may be used to indicate that at least one of the PEI or the paging subgroup is not required to be used only in the last used cell.

For example, in a case that the terminal receives a first indication, and the first indication is used to indicate that at least one of the PEI or the paging subgroup is used only in a last used cell of the terminal, if the current cell is indicated as a last used cell, the terminal uses at least one of the PEI or the paging subgroup in the current cell. In some embodiments, in a case that the terminal receives a first indication, if the first indication is used to indicate that at least one of the PEI or the paging subgroup is not required to be used only in a last used cell of the terminal, that is, indicating that the terminal may use at least one of the PEI or the paging subgroup in any cell, the terminal may use at least one of the PEI or the paging subgroup in the current cell. In some embodiments, if the system message or the RRC signaling received by the terminal in the current cell does not include a first indication, that is, it is not determined whether at least one of the PEI or the paging subgroup is used only in a last used cell, the terminal may use at least one of the PEI or the paging subgroup in the current cell.

In this embodiment of this application, the network side device may send the first indication to the terminal, and further flexibly configure, based on the first indication, the terminal to use the PEI and/or the paging subgroup. This ensures that the network side device and the terminal have a consistent understanding of using the PEI and/or the paging subgroup, and ensures that paging is successfully received.

In some embodiments, in a case that the terminal is assigned a core network subgroup identity in the current cell, the current cell provides a corresponding paging subgroup configuration, and the paging subgroup configuration is used for core-network-assigned subgrouping or core-network-controlled subgrouping.

In this embodiment of this application, if the terminal is assigned the Core Network subgroup Identity (CN subgroup ID) in the current cell, and the network side device provides the paging subgroup configuration for the current cell based on the system message, the terminal may use at least one of the PEI or the paging subgroup in the current cell. In this way, the terminal can determine, based on an identifier assigned by the network side device to the current cell, whether the PEI and/or the paging subgroup can be used, to ensure that the network side device and the terminal have a consistent understanding of using the PEI and/or the paging subgroup, and ensure that paging is successfully received. The paging subgroup configuration includes core-network-assigned subgrouping or core-network-controlled subgrouping (CN-assigned subgrouping or CN-controlled subgrouping).

In some embodiments, the target condition may further include at least one of the following:
the terminal supports at least one of the PEI or the paging subgroup; or
the current cell supports at least one of the PEI and/or the paging subgroup.

That the current cell supports the PEI and/or the paging subgroup includes that: the current cell indicates, based on the system message, non-access-stratum (NAS) service signaling, or RRC dedicated signaling (for example, an RRC release message), that the current cell supports the PEI and/or the paging subgroup. The paging subgroup includes at least one of the following:
a subgroup based on a UE identity (UE-ID based subgrouping); and
a subgroup assigned by a core network (CN-assigned subgrouping).

For a better understanding, the step 201 may further be represented as follows:

In a case that the target condition is met, the terminal uses at least one of the PEI or the paging subgroup in the current cell.

The target condition includes at least one of the following:

1. The current cell is a cell in which the terminal is released or suspended.

2. The current cell is a cell in which the terminal is most recently released or most recently suspended.

3. The current cell is a cell in which the terminal enters an idle state or an inactive state from a connected state.

4. The current cell is a cell in which the terminal most recently enters an idle state or an inactive state from a connected state.

5. The terminal receives a first indication, the first indication is used to indicate that at least one of the PEI or the paging subgroup is used only in a last used cell, and the UE is indicated that the current cell is the last used cell.

6. The terminal receives a first indication, and the first indication is used to indicate that at least one of the PEI or the paging subgroup is not required to be used only in a last used cell.

7. A system message or RRC signaling received by terminal in the current cell does not include a first indication.

8. The terminal is assigned a core network subgroup identity in the current cell, and the current cell provides a corresponding paging subgroup configuration, where the paging subgroup configuration is used for core-network-assigned subgrouping or core-network-controlled subgrouping.

9. The terminal receives a first indication, the first indication is used to indicate that at least one of the PEI or the paging subgroup is used only in a last used cell, and the terminal is released or suspended in the current cell.

10. The terminal receives a first indication, the first indication is used to indicate that at least one of the PEI or the paging subgroup is used only in a last used cell, and the terminal enters an idle state or an inactive state from a connected state in the current cell.

11. The terminal supports at least one of the PEI or the paging subgroup.

12. The current cell supports at least one of the PEI or the paging subgroup.

In this embodiment of this application, various cases of the target condition are determined, so that the terminal can determine a case that the PEI and/or the paging sub group can be used, to ensure that paging is successfully received.

In some embodiments, the method may further include:
after the terminal performs cell selection or cell reselection, the terminal performs a first operation based on the received first indication, where the first operation includes at least one of the following:
in a case that the first indication is used to indicate that at least one of the PEI or the paging subgroup is used only in a last used cell of the terminal, not using the PEI or the paging subgroup in the current cell; or
in a case that the first indication is used to indicate that at least one of the PEI or the paging subgroup is not required to be used only in a last used cell of the terminal, using at least one of the PEI or the paging subgroup in the current cell.

For example, after the terminal performs cell selection or cell reselection, the terminal may perform at least one of the following operations:
if the first indication received by the terminal is used to indicate that at least one of the PEI or the paging subgroup is used only in a last used cell of the terminal, the terminal does not use the PEI and/or the paging subgroup in the current cell; or
if the first indication received by the terminal is used to indicate that at least one of the PEI or the paging subgroup is not required to be used only in a last used cell of the terminal (or is used to indicate that the terminal uses at least one of the PEI or the paging subgroup in any cell), the terminal may use the PEI and/or the paging subgroup in the current cell.

The first indication may be sent by the network side device to the terminal. For example, the first indication is included in the system message or the RRC signaling sent by the network side device. In this embodiment of this application, whether the terminal that has performed cell selection or cell reselection can use the PEI or the paging subgroup in the current cell can also be configured based on the first indication sent by the network side device, to better standardize paging reception behavior of the terminal.

In some embodiments, in a case that the terminal is a terminal that camps on the current cell through cell selection or cell reselection, the terminal performs the first operation; or
in a case that the terminal is a terminal that is released or suspended in the current cell, the terminal does not perform the first operation.

In other words, only the terminal that is the terminal through cell selection or cell reselection can perform the first operation, and the terminal that is released or suspended in the current cell cannot perform the first operation.

In this embodiment of this application, the step 201 may include the following step:

In a case that the terminal is released or suspended in the current cell and the terminal camps on the current cell, if the current cell supports at least one of the PEI or the paging subgroup, the terminal uses at least one of the PEI or the paging subgroup in the current cell.

For example, after the terminal is released or suspended in a cell 1 and the terminal camps on the cell 1, if the cell 1 supports at least one of the PEI or the paging subgroup, the terminal uses at least one of the PEI or the paging subgroup in the cell 1.

In some embodiments, the current cell is the last used cell. For example, in a case that the terminal receives a first indication, where the first indication is used to indicate that at least one of the PEI or the paging subgroup is only in a last used cell of the terminal, the terminal is released or suspended in the current cell, and the terminal camps on the current cell, if the current cell supports at least one of the PEI or the paging subgroup, the terminal uses the PEI and/or the paging subgroup in the current cell. In this case, the current cell may be considered as the last used cell indicated in the first indication.

In some embodiments, in a case that the terminal is released or suspended in the current cell, if the terminal receives the first indication, the terminal ignores the first indication.

For example, in a case that the terminal is released or suspended in a cell 1 (a current cell), if the terminal receives a first indication, where the first indication is used to indicate that at least one of the PEI or the paging subgroup is used only in a last used cell of the terminal, the terminal may ignore the first indication. For example, regardless of whether the cell 1 is a last used cell in which the terminal uses the PEI and/or the paging subgroup, the terminal may use the PEI and/or the paging subgroup in the cell 1, to ensure that paging is successfully received on the terminal.

In this embodiment of this application, the method may further include:
in a case that the terminal is released or suspended in a target cell and the terminal moves from another cell back to the target cell, the terminal performs at least one of the following:
the terminal uses at least one of the PEI or the paging subgroup in the target cell;
the terminal determines, based on the first indication, whether at least one of the PEI or the paging subgroup is used in the target cell, where the first indication is used to indicate whether at least one of the PEI or the paging subgroup is used only in a last used cell of the terminal; and
the terminal autonomously determines whether at least one of the PEI or the paging subgroup is used in the target cell.

For example, the terminal is released or suspended in a cell 1 (a target cell), is reselected to a cell 2, and then returns to the cell 1. In this case, the terminal may use the PEI and/or the paging subgroup in the cell 1. In some embodiments, the terminal may determine, based on the received first indication, whether the PEI and/or the paging subgroup can be used in the cell 1. For example, the first indication indicates that at least one of the PEI or the paging subgroup is used only in a last used cell of the terminal. If the cell 1 is not the last used cell, the terminal does not use the PEI and/or the paging subgroup in the cell 1. In some embodiments, the terminal may autonomously determine whether to use the PEI and/or the paging subgroup. In this way, it is more flexible for the terminal to determine whether to use PEI and/or the paging subgroup.

In some embodiments, in a case that the terminal uses at least one of the PEI or the paging subgroup in the target cell, the target cell is the last used cell. In a case that the terminal is released or suspended in a target cell, if the terminal moves from another cell back to the target cell, the terminal uses the PEI and/or the paging subgroup in the target cell. In this case, the target cell is considered as the last used cell in the first indication. It should be noted that, if the terminal moves from the target cell to another cell, paging reception behavior of the terminal in the another cell may be determined based on the first indication.

In some embodiments, in a case that the terminal uses at least one of the PEI or the paging subgroup in the target cell, if the terminal is released or suspended in the current cell and the terminal receives the first indication, the terminal ignores the first indication.

For example, in a case that the terminal uses at least one of the PEI or the paging subgroup in a cell 1 (a target cell), if the terminal moves from the cell 1 to a cell 2, the terminal is released or suspended in the cell 2, and the terminal receives a first indication, where the first indication indicates that at least one of the PEI or the paging subgroup is only used in a last used cell of the terminal, the terminal may ignore the first indication, that is, the terminal may use the PEI and/or the paging subgroup in the cell 2, to ensure that paging is successfully received on the terminal.

In this embodiment of this application, before the terminal uses at least one of the PEI or the paging subgroup in the current cell, the method further includes:
the terminal receives a system message or a first RRC message, where the system message or the first RRC message includes at least one of the following:
a message used to indicate whether the terminal is allowed to use at least one of the PEI or the paging subgroup in the current cell;
a message used to indicate whether the current cell is a last used cell; and
a first indication, where the first indication is used to indicate whether at least one of the PEI or the paging subgroup is used only in a last used cell of the terminal.

It should be noted that the system message or the first RRC message is sent by the network side device to the terminal, and the terminal can determine, based on the system message or the first RRC message, whether to use the PEI and/or the paging subgroup in the current cell. For example, if the system message or the first RRC message indicates that the terminal is allowed to use the PEI and/or the paging subgroup in the current cell, the terminal uses the PEI and/or the paging subgroup in the current cell; or if the system message or the first RRC message indicates that the current cell is a last used cell, the terminal may use the PEI and/or the paging subgroup in the current cell; or if the system message or the first RRC message further includes a first indication, the terminal determines, based on the first indication, whether to use the PEI and/or the paging subgroup in the current cell; or if the system message or the first RRC message includes a first indication, and is further used to indicate that the current cell is a last used cell, the terminal may use the PEI and/or the paging subgroup in the current cell based on the first indication; or the like. Details are not specifically described in this embodiment.

In this way, the network side device can flexibly configure, based on the system message or the first RRC message, whether the terminal uses the PEI and/or the paging subgroup in the current cell. This ensures that the network side device and the terminal have a consistent understanding of using the PEI and/or the paging subgroup, and ensures that paging is successfully received.

In some embodiments, the method may further include:
the terminal sends a second RRC message used to request at least one of the PEI or the paging subgroup, where
the second RRC message includes at least one of the following:
terminal information;
terminal auxiliary information;
PEI use request information; or
an RRC resume request.

For example, the terminal sends, to the network side device, the second RRC message used to request the PEI and/or the paging subgroup, and the network side device sends the system message or the first RRC message to the terminal based on the received second RRC message. Message content of the system message or the first RRC message is described above, and details are not described herein again.

In this embodiment of this application, the terminal can actively request the PEI and/or the paging subgroup from the network side device, and the network side device further indicates to the terminal, based on a system message or an RRC message, a condition of using the PEI and/or the paging subgroup, to ensure that the network side device and the terminal have a consistent understanding of using the PEI and/or the paging subgroup.

For a better understanding, the following describes the technical solutions provided in this application by using several specific embodiments.

### Embodiment 1

A terminal camps on a current cell, and the terminal receives a system message sent by a network side device. If a first indication of the current cell indicates that at least one of a PEI or a paging subgroup is not required to be used only in a last used cell of the terminal, or the system message received by the current cell does not include a first indication, or the current cell is a cell in which the terminal is released or suspended, the terminal may use the PEI and/or the paging subgroup in this cell (namely, the current cell).

### Embodiment 2

A terminal is released or suspended in a cell 1, is reselected to a cell 2, and then returns to the cell 1 through cell selection or reselection. In this case, the terminal may perform at least one of the following operations:

Option 1: The terminal may use a PEI and/or a paging subgroup in the cell 1. Further, a current cell is considered as a “last used cell”, and the first indication (that is, indicating whether at least one of a PEI or a paging subgroup is used in a last used cell of the terminal) does not take effect for the terminal that is released or suspended in the current cell.

Option 2: The terminal determines, based on a first indication, whether to use a PEI and/or a paging subgroup in the cell 1.

Option 3: The terminal autonomously determines whether to use a PEI and/or a paging subgroup in the cell 1.

### Embodiment 3

A terminal is released or suspended in a cell 1, is reselected to a cell 2 and is released or suspended in the cell 2, and then returns to the cell 1 through cell selection or reselection. In this case, the terminal performs at least one of the following operations:

Option 1: The terminal may use a PEI and/or a paging subgroup in the cell 1. Further, a current cell is considered a “last used cell”.

Option 2: The terminal determines, based on a first indication, whether to use a PEI and/or a paging subgroup in the cell 1.

Option 3: The terminal autonomously determines whether to use a PEI and/or a paging subgroup in the cell 1.

### Embodiment 4

A terminal receives an RRC message such as a release or suspension message, where the RRC message indicates at least one of the following:
whether to use a PEI and/or a paging subgroup;
whether a current cell is a last used cell; or
a first indication.

Further, before a network side device sends an RRC message to indicate whether to use a PEI and/or a paging subgroup, the terminal sends the RRC message used to request to use the PEI and/or the paging subgroup. The RRC message sent by the terminal includes at least one of the following:
terminal information;
terminal auxiliary information;
PEI use request information; or
an RRC resume request.

In the foregoing embodiment, the network side device may flexibly configure the terminal to use the PEI and/or the paging subgroup to define behavior of the terminal after cell selection or cell reselection, and behavior of the terminal after connection release or suspension. This helps the network side device and the terminal have a consistent understanding of using the PEI and/or the paging subgroup, and ensures that paging is successfully received.

FIG. 3 is a flowchart of another paging indication method according to an embodiment of this application. As shown in FIG. 3, the method includes the following step:

Step 301: A network side device sends a system message or a first RRC message to a terminal.

The system message or the first RRC message includes at least one of the following:
a message used to indicate whether the terminal is allowed to use at least one of a paging early indication PEI or a paging subgroup in a current cell;
a message used to indicate whether a current cell on which the terminal camps is a last used cell; or
a first indication, where the first indication is used to indicate whether at least one of a PEI or a paging subgroup is used only in a last used cell of the terminal.

In this embodiment of this application, the network side device sends the system message or the first RRC message to the terminal, and the terminal can determine, based on the system message or the first RRC message, whether to use the PEI and/or the paging subgroup in the current cell. For example, if the system message or the first RRC message indicates that the terminal is allowed to use the PEI and/or the paging subgroup in the current cell, the terminal uses the PEI and/or the paging subgroup in the current cell; or if the system message or the first RRC message indicates that the current cell is a last used cell, the terminal may use the PEI and/or the paging subgroup in the current cell; or if the system message or the first RRC message further includes a first indication, the terminal determines, based on the first indication, whether to use the PEI and/or the paging subgroup in the current cell; or if the system message or the first RRC message includes a first indication, and is further used to indicate that the current cell is a last used cell, the terminal may use the PEI and/or the paging subgroup in the current cell based on the first indication; or the like. Details are not specifically described in this embodiment.

In this way, the network side device can flexibly configure, based on the system message or the first RRC message, whether the terminal uses the PEI and/or the paging subgroup in the current cell. This ensures that the network side device and the terminal have a consistent understanding of using the PEI and/or the paging subgroup, and ensures that paging is successfully received.

In some embodiments, the method may further include:
the network side device receives a second RRC message sent by the terminal, where the second RRC message is used to request at least one of the PEI or the paging subgroup; and
the second RRC message includes at least one of the following:
terminal information;
terminal auxiliary information;
PEI use request information; or
an RRC resume request.

For example, the terminal sends, to the network side device, the second RRC message used to request the PEI and/or the paging subgroup, and the network side device sends the system message or the first RRC message to the terminal based on the received second RRC message. Message content of the system message or the first RRC message is described above, and details are not described herein again.

In this embodiment of this application, the terminal can actively request the PEI and/or the paging subgroup from the network side device, and the network side device further indicates to the terminal, based on a system message or an RRC message, a condition of using the PEI and/or the paging subgroup, to ensure that the network side device and the terminal have a consistent understanding of using the PEI and/or the paging subgroup.

It should be noted that the network side device may be a base station or a core network device. In some embodiments, the network side device is a base station; and in a case that the system message or the first RRC message includes the message used to indicate whether a current cell on which the terminal camps is a last used cell, the method further includes:
the base station sends a second indication to a core network device, where the second indication is used to indicate whether the current cell is a last used cell.

For example, the base station sends the system message or the first RRC message to the terminal, and indicates to the terminal, based on the system message or the first RRC message, whether the current cell on which the terminal camps is a last used cell. In this case, the base station can further send the second indication to the core network device, to indicate to the core network device, whether the current cell on which the terminal camps is a last used cell. In other words, the base station may simultaneously indicate to the terminal and the core network device, whether the current cell is a last used cell. This ensures a consistent understanding of the last used cell by a communication system, and ensures that paging is successfully received.

The paging indication method provided in this embodiment of this application may be executed by a paging indication apparatus. In this embodiment of this application, the paging indication apparatus provided in the embodiments of this application is described by using an example in which the paging indication apparatus performs the paging indication method.

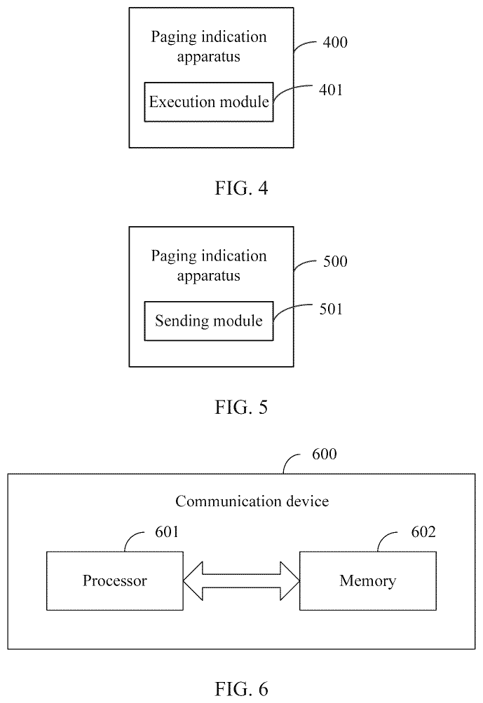

FIG. 4 is a structural diagram of a paging indication apparatus according to an embodiment of this application. As shown in FIG. 4, the paging indication apparatus 400 includes:
an execution module 401, configured to: in a case that a target condition is met, use at least one of a paging early indication (PEI) or a paging subgroup in a current cell, where
the target condition includes at least one of the following:
the apparatus is in a non-connected state in the current cell;
the current cell does not restrict the apparatus from using at least one of the PEI or the paging subgroup; or
the apparatus is assigned a core network subgroup identity in the current cell.

In some embodiments, that the apparatus is in a non-connected state in the current cell includes at least one of the following:
the apparatus is released in the current cell, or the apparatus is suspended in the current cell; or
the apparatus enters an idle state or an inactive state from a connected state in the current cell.

In some embodiments, that the apparatus is released in the current cell, or the apparatus is suspended in the current cell includes:
the apparatus is most recently released in the current cell, or the apparatus is most recently suspended in the current cell.

In some embodiments, that the apparatus enters an idle state or an inactive state from a connected state in the current cell includes:
the apparatus most recently enters the idle state or the inactive state from the connected state in the current cell.

In some embodiments, that the current cell does not restrict the apparatus from using at least one of the PEI or the paging subgroup is implemented based on any one of the following:
the apparatus receives a first indication, and the first indication is used to indicate that at least one of the PEI or the paging subgroup is not required to be used only in a last used cell of the apparatus; or
a system message or radio resource control RRC signaling received by the apparatus in the current cell does not include a first indication, and the first indication is used to indicate whether at least one of the PEI or the paging subgroup is used only in a last used cell of the apparatus

In some embodiments, in a case that the apparatus is assigned a core network subgroup identity in the current cell, the current cell provides a corresponding paging subgroup configuration, and the paging subgroup configuration is used for core-network-assigned subgrouping or core-network-controlled subgrouping.

In some embodiments, the execution module 401 is further configured to:
in a case that the apparatus performs cell selection or cell reselection, perform a first operation based on a received first indication, where the first operation includes at least one of the following:
in a case that the first indication is used to indicate that at least one of the PEI or the paging subgroup is used only in a last used cell of the apparatus, not using the PEI or the paging subgroup in the current cell; or
in a case that the first indication is used to indicate that at least one of the PEI or the paging subgroup is not required to be used only in a last used cell of the apparatus, using at least one of the PEI or the paging subgroup in the current cell.

In some embodiments, in a case that the apparatus is an apparatus that camps on the current cell through cell selection or cell reselection, the apparatus performs the first operation; or
in a case that the apparatus is an apparatus that is released or suspended in the current cell, the apparatus does not perform the first operation.

In some embodiments, in a case that the apparatus is released or suspended in a current cell and the apparatus camps on the current cell, if the current cell supports at least one of the PEI or the paging subgroup, the execution module 401 is further configured to use at least one of the PEI or the paging subgroup in the current cell.

In some embodiments, the current cell is the last used cell.

In some embodiments, in a case that the apparatus is released or suspended in the current cell, if the apparatus receives a first indication, the apparatus ignores the first indication, where
the first indication is used to indicate whether at least one of the PEI or the paging subgroup is used only in a last used cell of the apparatus.

In some embodiments, in a case that the apparatus is released or suspended in a target cell and the apparatus moves from another cell back to the target cell, the execution module 401 is further configured to perform at least one of the following:
using at least one of the PEI or the paging subgroup in the target cell;
determining, based on a first indication, whether at least one of the PEI or the paging subgroup is used in the target cell, where the first indication is used to indicate whether at least one of the PEI or the paging subgroup is used only in a last used cell of the apparatus; and
autonomously determining whether at least one of the PEI or the paging subgroup is used in the target cell.

In some embodiments, in a case that the apparatus uses at least one of the PEI or the paging subgroup in the target cell, the target cell is the last used cell.

In some embodiments, in a case that the apparatus uses at least one of the PEI or the paging subgroup in the target cell, if the apparatus is released or suspended in the current cell and receives the first indication, the apparatus ignores the first indication.

In some embodiments, the apparatus further includes:
a first receiving module, configured to receive a system message or a first RRC message, where the system message or the first RRC message includes at least one of the following:
a message used to indicate whether the apparatus is allowed to use at least one of the PEI or the paging subgroup in the current cell;
a message used to indicate whether the current cell is a last used cell; and
a first indication, where the first indication is used to indicate whether at least one of the PEI or the paging subgroup is used only in a last used cell of the apparatus.

In some embodiments, the apparatus further includes:
a sending module, configured to send a second RRC message used to request at least one of the PEI or the paging subgroup, where
the second RRC message includes at least one of the following:
terminal information;
terminal auxiliary information;
PEI use request information; and
an RRC resume request.

In this embodiment of this application, the apparatus can determine a case that the PEI and/or the paging subgroup can be used, and a network side device can flexibly configure the apparatus to use the PEI and/or the paging subgroup. This ensures that the network side device and the apparatus have a consistent understanding of using the PEI and/or the paging subgroup, avoids a case that paging is lost, and ensures that paging is successfully received.

The paging indication apparatus in this embodiment of this application may be an electronic device, for example, an electronic device with an operating system, or may be a component in an electronic device, for example, an integrated circuit or a chip. The electronic device may be a terminal, or may be another device other than the terminal. For example, the terminal may include but be not limited to the foregoing listed types of the terminal 11. The another device may be a server, a Network Attached Storage (NAS), or the like. This is not specifically limited in this embodiment of this application.

The paging indication apparatus provided in this embodiment of this application can implement the processes implemented by the terminal in the method embodiment in FIG. 2, and a same technical effect can be achieved. To avoid repetition, details are not described herein again.

FIG. 5 is a structural diagram of another paging indication apparatus according to an embodiment of this application. As shown in FIG. 5, the paging indication apparatus 500 includes:
a sending module 501, configured to send a system message or a first radio resource control RRC message to a terminal, where the system message or the first RRC message includes at least one of the following:
a message used to indicate whether the terminal is allowed to use at least one of a paging early indication PEI and a paging subgroup in a current cell;
a message used to indicate whether a current cell on which the terminal camps is a last used cell; and
a first indication, where the first indication is used to indicate whether at least one of a PEI and a paging subgroup is used only in a last used cell of the terminal.

In some embodiments, the apparatus further includes:
a second receiving module, configured to receive a second RRC message sent by the terminal, where the second RRC message is used to request at least one of the PEI or the paging subgroup; and
the second RRC message includes at least one of the following:
terminal information;
terminal auxiliary information;
PEI use request information; and
an RRC resume request.

In some embodiments, the apparatus is a base station; and in a case that the system message or the first RRC message includes the message used to indicate whether a current cell on which the terminal camps is a last used cell, the sending module is further configured to:
send a second indication to a core network device, where the second indication is used to indicate whether the current cell is a last used cell.

In this embodiment of this application, the apparatus can flexibly configure, based on the system message or the first RRC message, whether the terminal uses the PEI and/or the paging subgroup in the current cell, to ensure that paging is successfully received.

The paging indication apparatus provided in this embodiment of this application can implement the processes implemented by the network side device in the method embodiment in FIG. 3, and a same technical effect can be achieved. To avoid repetition, details are not described herein again.

As shown in FIG. 6, an embodiment of this application further provides a communication device 600, including a processor 601 and a memory 602, and the memory 602 stores a program or an instruction that can be run on the processor 601. For example, in a case that the communication device 600 is a terminal, when the program or the instruction is executed by the processor 601, the steps of the method embodiment in FIG. 2 are implemented, and a same technical effect can be achieved. In a case that the communication device 600 is a network side device, when the program or the instruction is executed by the processor 601, the steps of the method embodiment in FIG. 3 are implemented, and a same technical effect can be achieved. To avoid repetition, details are not described herein again.

An embodiment of this application further provides a terminal, including a processor and a communication interface. The processor is configured to: in a case that a target condition is met, use at least one of a paging early indication PEI and a paging subgroup in a current cell, where the target condition includes at least one of the following:
the terminal is in a non-connected state in the current cell;
the current cell does not restrict the terminal from using at least one of the PEI or the paging subgroup; and
the terminal is assigned a core network subgroup identity in the current cell.

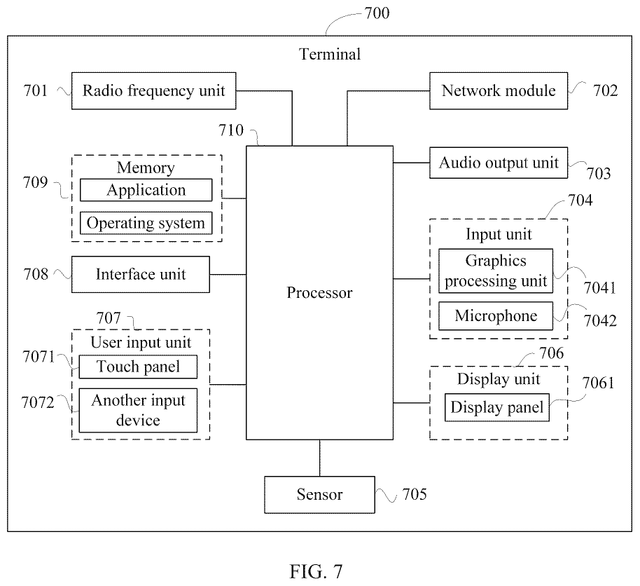

The terminal embodiment corresponds to the terminal side method embodiment, each implementation process and implementation of the method embodiment may be applicable to the terminal embodiment, and a same technical effect can be achieved. FIG. 7 is a schematic diagram of a hardware structure of a terminal according to an embodiment of this application.

The terminal 700 includes but is not limited to at least some of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but be not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, an application or an instruction required by at least one function (for example, a sound playing function or an image playing function), and the like. In addition, the memory 709 may be a volatile memory or a non-volatile memory, or the memory 709 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 709 in this embodiment of this application includes but is not limited to these memories and any memory of another proper type.

The processor 710 may include one or more processing units. In some embodiments, an application processor and a modem processor are integrated into the processor 710. The application processor mainly processes an operating system, a user interface, an application, or the like. The modem processor mainly processes a wireless communication signal, for example, a baseband processor. It may be understood that, the modem processor may not be integrated into the processor 710.

The processor 710 is configured to: in a case that a target condition is met, use at least one of a paging early indication (PEI) or a paging subgroup in a current cell, where
the target condition includes at least one of the following:
the terminal is in a non-connected state in the current cell;
the current cell does not restrict the terminal from using at least one of the PEI or the paging subgroup; or
the terminal is assigned a core network subgroup identity in the current cell.

In some embodiments, that the terminal is in a non-connected state in the current cell includes at least one of the following:
the terminal is released in the current cell, or the terminal is suspended in the current cell; and
the terminal enters an idle state or an inactive state from a connected state in the current cell.

In some embodiments, that the terminal is released in the current cell, or the terminal is suspended in the current cell includes:
the terminal is most recently released in the current cell, or the terminal is most recently suspended in the current cell.

In some embodiments, that the terminal enters an idle state or an inactive state from a connected state in the current cell includes:
the terminal most recently enters the idle state or the inactive state from the connected state in the current cell.

In some embodiments, that at least one of the PEI or the paging subgroup can be used in any cell is implemented based on any one of the following:
the radio frequency unit 701 receives a first indication, and the first indication is used to indicate that at least one of the PEI or the paging subgroup is not required to be used only in a last used cell of the terminal; or
a system message or radio resource control RRC signaling received by the radio frequency unit 701 in the current cell does not include a first indication, and the first indication is used to indicate whether at least one of the PEI or the paging subgroup is used only in a last used cell of the terminal.

In some embodiments, in a case that the terminal is assigned a core network subgroup identity in the current cell, the current cell provides a corresponding paging subgroup configuration, and the paging subgroup configuration is used for core-network-assigned subgrouping or core-network-controlled subgrouping.

In some embodiments, in a case that the terminal performs cell selection or cell reselection, the processor 710 performs a first operation based on a received first indication, where the first operation includes at least one of the following:
in a case that the first indication is used to indicate that at least one of the PEI or the paging subgroup is used only in a last used cell of the terminal, not using the PEI or the paging subgroup in the current cell; or
in a case that the first indication is used to indicate that at least one of the PEI or the paging subgroup is not required to be used only in a last used cell of the terminal, using at least one of the PEI or the paging subgroup in the current cell.

In some embodiments, in a case that the terminal is a terminal that camps on the current cell through cell selection or cell reselection, the processor 710 performs the first operation; or
in a case that the terminal is a terminal that is released or suspended in the current cell, the processor 710 does not perform the first operation.

In some embodiments, in a case that the terminal is released or suspended in the current cell and the terminal camps on the current cell, if the current cell supports at least one of the PEI or the paging subgroup, the processor 710 uses at least one of the PEI or the paging subgroup in the current cell.

In some embodiments, the current cell is the last used cell.

In some embodiments, in a case that the terminal is released or suspended in the current cell, if the radio frequency unit 701 receives a first indication, the terminal ignores the first indication, where
the first indication is used to indicate whether at least one of the PEI or the paging subgroup is used only in a last used cell of the terminal.

In some embodiments, in a case that the terminal is released or suspended in a target cell and the terminal moves from another cell back to the target cell, the processor 710 performs at least one of the following:
using at least one of the PEI or the paging subgroup in the target cell;
determining, based on a first indication, whether at least one of the PEI or the paging subgroup is used in the target cell, where the first indication is used to indicate whether at least one of the PEI or the paging subgroup is used only in a last used cell of the terminal; and
autonomously determining whether at least one of the PEI or the paging subgroup is used in the target cell.

In some embodiments, in a case that the terminal uses at least one of the PEI or the paging subgroup in the target cell, the target cell is the last used cell.

In some embodiments, in a case that the terminal uses at least one of the PEI or the paging subgroup in the target cell, if the terminal is released or suspended in the current cell and the terminal receives the first indication, the terminal ignores the first indication.

In some embodiments, the radio frequency unit 701 is further configured to:
receive a system message or a first RRC message, where the system message or the first RRC message includes at least one of the following:
a message used to indicate whether the terminal is allowed to use at least one of the PEI or the paging subgroup in the current cell;
a message used to indicate whether the current cell is a last used cell; and
a first indication, where the first indication is used to indicate whether at least one of the PEI or the paging subgroup is used only in a last used cell of the terminal.

In some embodiments, the radio frequency unit 701 is further configured to:
send a second RRC message used to request at least one of the PEI or the paging subgroup, where
the second RRC message includes at least one of the following:
terminal information;
terminal auxiliary information;
PEI use request information; and
an RRC resume request.

In this embodiment of this application, in a case that the target condition is met, the terminal uses at least one of the PEI or the paging subgroup in the current cell. In this way, the terminal can determine a case that the PEI and/or the paging subgroup can be used, and a network side device can flexibly configure the terminal to use the PEI and/or the paging subgroup. This ensures that the network side device and the terminal have a consistent understanding of using the PEI and/or the paging subgroup, avoids a case that paging is lost, ensures that paging is successfully received, and ensures communication between the terminal and the network side device.

An embodiment of this application further provides a network side device, including a processor and a communication interface. The communication interface is configured to send a system message or a first radio resource control RRC message to a terminal, where the system message or the first RRC message includes at least one of the following:
a message used to indicate whether the terminal is allowed to use at least one of a paging early indication PEI and a paging subgroup in a current cell;
a message used to indicate whether a current cell on which the terminal camps is a last used cell; and
a first indication, where the first indication is used to indicate whether at least one of a PEI and a paging subgroup is used only in a last used cell of the terminal.

In this embodiment of this application, the network side device embodiment corresponds to the method embodiment of the network side device. Each implementation process and implementation of the method embodiment may be applicable to the network side device embodiment, and a same technical effect can be achieved.

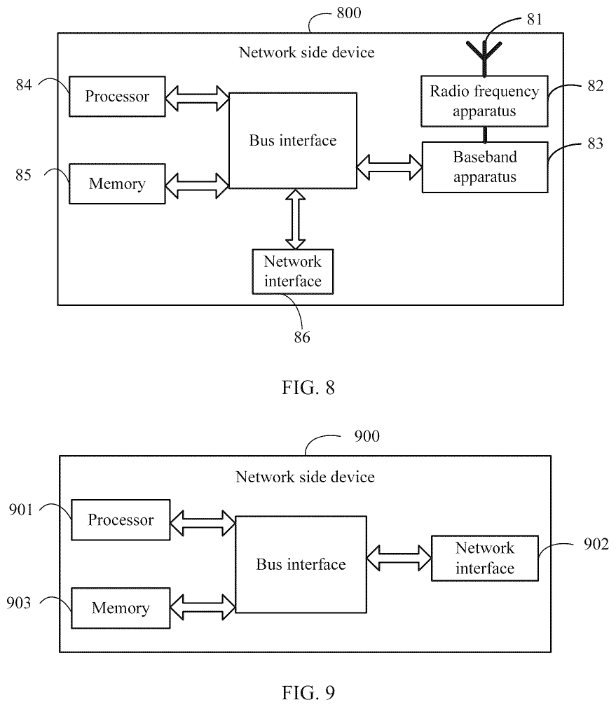

An embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 through a bus interface, to invoke a program in the memory 85 to perform the operations of the network device shown in the foregoing method embodiment.

The network side device may further include a network interface 86, and the interface is, for example, a common public radio interface (CPRI).

The network side device 800 in this embodiment of this application further includes an instruction or a program that is stored in the memory 85 and that can be run on the processor 84. The processor 84 invokes the instruction or the program in the memory 85 to perform the method performed by the modules shown in FIG. 8, and a same technical effect is achieved. To avoid repetition, details are not described herein again.

An embodiment of this application further provides another network side device. As shown in FIG. 9, the network side device 900 includes a processor 901, a network interface 902, and a memory 903. The network interface 902 is, for example, a common public radio interface (CPRI).

The network side device 900 in this embodiment of the present application further includes an instruction or a program that is stored in the memory 903 and that can be run on the processor 901. The processor 901 invokes the instruction or the program in the memory 903 to perform the method performed by the modules shown in FIG. 9, and a same technical effect is achieved. To avoid repetition, details are not described herein again.

An embodiment of this application further provides a readable storage medium. The readable storage medium stores a program or an instruction. When the program or the instruction is executed by a processor, the processes of the method embodiment in FIG. 2 or the processes of the method embodiment in FIG. 3 are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, the processor is configured to run a program or an instruction, to implement the processes of the method embodiment in FIG. 2 or the processes of the method embodiment in FIG. 3, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium, the computer program/program product is executed by at least one processor, to implement the processes of the method embodiment in FIG. 2 or the processes of the method embodiment in FIG. 3, and a same technical effect can be achieved. To avoid repetition, details are not described herein again.

An embodiment of this application further provides a communication system, including a terminal and a network side device. The terminal may be configured to perform the steps of the method embodiment in FIG. 2, and the network side device may be configured to perform the steps of the method embodiment in FIG. 3.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for paging indication, comprising:
when a target condition is met, using, by a terminal, at least one of a paging early indication (PEI) or a paging subgroup in a current cell,
wherein the target condition comprises at least one of the following:
the terminal is in a non-connected state in the current cell;
the current cell does not restrict the terminal from using at least one of the PEI or the paging subgroup; or
the terminal is assigned a core network subgroup identity in the current cell.

2. The method according to claim 1, wherein that the terminal is in a non-connected state in the current cell comprises at least one of the following:
the terminal is released in the current cell, or the terminal is suspended in the current cell; or
the terminal enters an idle state or an inactive state from a connected state in the current cell.

3. The method according to claim 2, wherein that the terminal is released in the current cell, or the terminal is suspended in the current cell comprises:
the terminal is most recently released in the current cell, or the terminal is most recently suspended in the current cell.

4. The method according to claim 2, wherein that the terminal enters an idle state or an inactive state from a connected state in the current cell comprises:
the terminal most recently enters the idle state or the inactive state from the connected state in the current cell.

5. The method according to claim 1, wherein that the current cell does not restrict the terminal from using at least one of the PEI or the paging subgroup is implemented based on any one of the following:
the terminal receives a first indication, and the first indication is used to indicate that at least one of the PEI or the paging subgroup is not required to be used only in a last used cell of the terminal; or
a system message or radio resource control (RRC) signaling received by the terminal in the current cell does not comprise a first indication, and the first indication is used to indicate whether at least one of the PEI or the paging subgroup is used only in a last used cell of the terminal.

6. The method according to claim 1, wherein when the terminal is assigned a core network subgroup identity in the current cell, the current cell provides a corresponding paging subgroup configuration, and the paging subgroup configuration is used for core-network-assigned subgrouping or core-network-controlled subgrouping.

7. The method according to claim 1, further comprising:
when the terminal performs cell selection or cell reselection, performing, by the terminal, a first operation based on a received first indication, wherein the first operation comprises at least one of the following:
when the first indication is used to indicate that at least one of the PEI or the paging subgroup is used only in a last used cell of the terminal, skipping using the PEI or the paging subgroup in the current cell; or
when the first indication is used to indicate that at least one of the PEI or the paging subgroup is not required to be used only in a last used cell of the terminal, using at least one of the PEI or the paging subgroup in the current cell.

8. The method according to claim 7, wherein when the terminal is a terminal that camps on the current cell through cell selection or cell reselection, performing, by the terminal, the first operation; or
when the terminal is a terminal that is released or suspended in the current cell, skipping performing, by the terminal, the first operation.

9. The method according to claim 1, wherein when the target condition is met, the using, by a terminal, at least one of a PEI or a paging subgroup in a current cell comprises:
when the terminal is released or suspended in the current cell and the terminal camps on the current cell, in response to the current cell supporting at least one of the PEI or the paging subgroup, using, by the terminal, at least one of the PEI or the paging subgroup in the current cell.

10. The method according to claim 9, wherein the current cell is a last used cell.

11. The method according to claim 9, wherein when the terminal is released or suspended in the current cell, in response to the terminal receiving a first indication, ignoring, by the terminal, the first indication,
wherein the first indication is used to indicate whether at least one of the PEI or the paging subgroup is used only in a last used cell of the terminal.

12. The method according to claim 1, further comprising:
when the terminal is released or suspended in a target cell and the terminal moves from another cell back to the target cell, performing, by the terminal, at least one of the following:
using, by the terminal, at least one of the PEI or the paging subgroup in the target cell;
determining, by the terminal based on a first indication, whether at least one of the PEI or the paging subgroup is used in the target cell, wherein the first indication is used to indicate whether at least one of the PEI or the paging subgroup is used only in a last used cell of the terminal; or
autonomously determining, by the terminal, whether at least one of the PEI or the paging subgroup is used in the target cell.

13. The method according to claim 12, wherein when the terminal uses at least one of the PEI or the paging subgroup in the target cell, the target cell is a last used cell.

14. The method according to claim 12, wherein when the terminal uses at least one of the PEI or the paging subgroup in the target cell, in response to the terminal being released or suspended in the current cell and the terminal receiving the first indication, ignoring, by the terminal, the first indication.

15. The method according to claim 1, wherein before the using, by a terminal, at least one of a PEI or a paging subgroup in a current cell, the method further comprises:
receiving, by the terminal, a system message or a first RRC message, wherein the system message or the first RRC message comprises at least one of the following:
a message used to indicate whether the terminal is allowed to use at least one of the PEI or the paging subgroup in the current cell;
a message used to indicate whether the current cell is a last used cell; or
a first indication, wherein the first indication is used to indicate whether at least one of the PEI or the paging subgroup is used only in a last used cell of the terminal.

16. The method according to claim 1, further comprising:
sending, by the terminal, a second RRC message used to request at least one of the PEI or the paging subgroup,
wherein the second RRC message comprises at least one of the following:
terminal information;
terminal auxiliary information;
PEI use request information; or
an RRC resume request.

17. A method for paging indication, comprising:
sending, by a network side device, a system message or a first radio resource control (RRC) message to a terminal, wherein the system message or the first RRC message comprises at least one of the following:
a message used to indicate whether the terminal is allowed to use at least one of a paging early indication (PEI) or a paging subgroup in a current cell;
a message used to indicate whether a current cell on which the terminal camps is a last used cell; or
a first indication, wherein the first indication is used to indicate whether at least one of the PEI or the paging subgroup is used only in a last used cell of the terminal.

18. The method according to claim 17, further comprising:
receiving, by the network side device, a second RRC message sent by the terminal, wherein the second RRC message is used to request at least one of the PEI or the paging subgroup; and
the second RRC message comprises at least one of the following:
terminal information;
terminal auxiliary information;
PEI use request information; or
an RRC resume request.

19. The method according to claim 17, wherein the network side device is a base station, and when the system message or the first RRC message comprises the message used to indicate whether a current cell on which the terminal camps is a last used cell, the method further comprises:
sending, by the base station, a second indication to a core network device, wherein the second indication is used to indicate whether the current cell is a last used cell.

20. A terminal, comprising: a memory storing a computer program; and a processor coupled to the memory and configured to execute the computer program to perform operations comprising:
when a target condition is met, using, by the terminal, at least one of a paging early indication (PEI) or a paging subgroup in a current cell,
wherein the target condition comprises at least one of the following:
the terminal is in a non-connected state in the current cell;
the current cell does not restrict the terminal from using at least one of the PEI or the paging subgroup; or
the terminal is assigned a core network subgroup identity in the current cell.
